(19) United States
(12) Patent Application Publication
(10) Pub. No.: US 2023/0016242 A1
(43) Pub. Date: Jan. 19, 2023

(54) Processing Apparatus, Processing Method, and Storage Medium

(71) Applicant: Yamaha Corporation, Hamamatsu-shi (JP)

(72) Inventors: Yu TAKAHASHI, Hamamatsu-shi (JP); Tetsuro OTAKE, Hamamatsu-shi (JP)

(21) Appl. No.: 17/949,717

(22) Filed: Sep. 21, 2022

Related U.S. Application Data
(63) Continuation of application No. PCT/JP2020/045672, filed on Dec. 8, 2020.

(30) Foreign Application Priority Data
Mar. 23, 2020 (JP) 2020-051019

(51) Int. Cl. G10L 25/30; G10L 25/18; G10L 21/0308

(52) U.S. Cl. CPC G10L 25/30; G10L 25/18; G10L 21/0308

(57) ABSTRACT

A processing apparatus includes one or more processors and one or more memories operatively coupled to the one or more processors. The one or more processors are configured to acquire a spectrogram of a sound signal. The one or more processors are also configured to perform a first convolution on the spectrogram at every predetermined width on one of a frequency axis or a time axis. The one or more processors are also configured to combine results of the first convolution to obtain one-dimensional first feature data. The one or more processors are also configured to perform at least one second convolution on the one-dimensional first feature data to obtain one-dimensional second feature data indicating a feature of the spectrogram.

### CROSS-REFERENCE TO RELATED APPLICATION

This application is a continuation application of International Application PCT/JP2020/045672 filed on Dec. 8, 2020, the content of this application is incorporated herein by reference in their entirety.

### BACKGROUND

The present disclosure relates to a processing apparatus, a processing method, and a storage medium.

In recent years, a technology for analyzing a spectrogram of a sound signal through use of a learning model has been investigated. For example, in Andreas Jansson, Eric Humphrey, Nicola Montecchio, Rachel Bittner, Aparna Kumar, Tillman Weyde, “SINGING VOICE SEPARATION WITH DEEP U-NET CONVOLUTIONAL NETWORKS,” ISMIR, 2017, there is described a technology for obtaining two-dimensional feature data by repeatedly performing a two-dimensional convolution on a spectrogram of a sound signal in which a plurality of sounds are mixed. In this technology, a mask for separating a predetermined sound from a mixed sound of a plurality of sounds is generated based on the two-dimensional feature data.

### SUMMARY

However, only local information on a spectrogram is considered at a time of a convolution in such a technology for obtaining two-dimensional feature data as described in Andreas Jansson, Eric Humphrey, Nicola Montecchio, Rachel Bittner, Aparna Kumar, Tillman Weyde, “SINGING VOICE SEPARATION WITH DEEP U-NET CONVOLUTIONAL NETWORKS,” ISMIR, 2017. For example, a voice having a harmonic structure up to a high frequency has characteristic information over a wide range in a frequency direction, and hence it is not possible to accurately obtain feature data on the voice in consideration of only the local information. In order to obtain accurate feature data in consideration of feature amounts distributed throughout the spectrogram, it is required to deepen layers of a learning model or use a large filter, and hence it is not possible to obtain feature data that efficiently represents features of the spectrogram.

The present disclosure has been made in view of the above-mentioned problems, and has an object to obtain feature data that efficiently represents features of a spectrogram of a sound signal.

In order to solve the above-mentioned problems, according to at least one embodiment of the present disclosure, there is provided a method implemented by a computer, the method including: acquiring a spectrogram of a sound signal; performing a first convolution on the spectrogram every predetermined width on one of a frequency axis or a time axis; combining results of the first convolution performed every predetermined width to obtain one-dimensional first feature data; and performing at least one second convolution on the one-dimensional first feature data to obtain one-dimensional second feature data indicating a feature of the spectrogram.

According to at least one embodiment of the present disclosure, there is provided a processing system including: one or more processors; and one or more memories, wherein the one or more processors are configured to, by executing a program stored in the one or more memories: acquire a spectrogram of a sound signal; perform a first convolution on the spectrogram every predetermined width on one of a frequency axis or a time axis; combine results of the first convolution performed every predetermined width to obtain one-dimensional first feature data; and perform at least one second convolution on the one-dimensional first feature data to obtain one-dimensional second feature data indicating a feature of the spectrogram.

According to at least one embodiment of the present disclosure, there is provided a non-transitory storage medium to be used as one or more storage media having stored thereon a computer-readable program, the computer-readable program causing one or more processors to perform the operations of: acquiring a spectrogram of a sound signal; performing a first convolution on the spectrogram every predetermined width on one of a frequency axis or a time axis; combining results of the first convolution performed every predetermined width to obtain one-dimensional first feature data; and performing at least one second convolution on the one-dimensional first feature data to obtain one-dimensional second feature data indicating a feature of the spectrogram.

### BRIEF DESCRIPTION OF THE DRAWINGS

FIG. 1 is a diagram for illustrating an example of a processing device;

FIG. 2 is a block diagram for illustrating an example of functions implemented by the processing device;

FIG. 3 is a view for showing an example of a spectrogram of a sound signal;

FIG. 4 is a diagram for illustrating an overall flow of processing to be executed by a learning model;

FIG. 5 is a diagram for illustrating how a two-dimensional spectrogram is regarded as a one-dimensional signal;

FIG. 6 is a diagram for illustrating processing in which the one-dimensional signal is convolved;

FIG. 7 is a flow chart for illustrating an example of adjustment processing; and

FIG. 8 is a flow chart for illustrating an example of separation processing.

### DETAILED DESCRIPTION

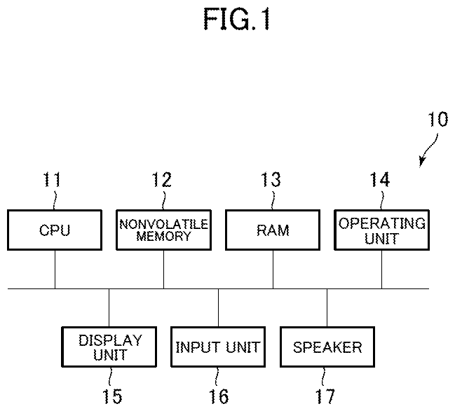

Now, an example of at least one embodiment of the present disclosure is described with reference to the accompanying drawings. FIG. 1 is a diagram for illustrating an example of a processing device according to the at least one embodiment. For example, the processing device 10 is a computer device such as a digital mixer, a signal processing engine, an audio device, an electronic musical instrument, an effects unit, a personal computer, a smartphone, or a tablet terminal. As illustrated in FIG. 1, the processing device 10 is connected to a CPU 11, a nonvolatile memory 12, a RAM 13, an operating unit 14, a display unit 15, an input unit 16, and a speaker 17.

The CPU 11 includes at least one processor. The at least one processor is not limited to a plurality of processors in one chip, and may be a plurality of processors distributed in a plurality of devices connected by a network or the like. The CPU 11 executes predetermined processing based on a program and data that are stored in the nonvolatile memory 12. The nonvolatile memory 12 is a memory, such as a ROM, an EEPROM, a flash memory, or a hard disk drive. The RAM 13 is an example of a volatile memory. The operating unit 14 is an input device, such as a touch panel, a keyboard, a mouse, a button, or a lever. The display unit 15 is a display, such as a liquid crystal display or an organic EL display.

The input unit 16 acquires a sound signal. The sound signal is a signal indicating a sound. An acoustic signal or a voice signal is a kind of sound signal. The sound is not limited to a voice uttered by a human. The sound signal may indicate any sound. For example, the sound signal may indicate a sound made by a non-human animal, music, a sound included in a moving image, a sound of a machine, a sound of a vehicle, a sound of a natural phenomenon, or a sound in which at least two of those sounds are mixed. In the at least one embodiment, a case in which the sound signal is a digital signal is described. The sound signal may be an analog signal. The input unit 16 converts a digital sound signal into an analog sound signal, and inputs the analog sound signal to the speaker 17. The speaker 17 outputs a sound corresponding to the input analog sound signal.

In the at least one embodiment, “obtaining” means obtaining as a result of processing. For example, feature data described later is obtained as a result of processing performed by a learning model described later, and hence the processing device 10 “obtains” the feature data. The “obtaining” can also be rephrased as creating, defining, or generating. Meanwhile, “acquiring” means receiving. For example, in the at least one embodiment, a spectrogram of a sound signal is received from the nonvolatile memory 12, and hence the processing device 10 acquires the spectrogram. The “acquiring” can also be rephrased as receiving. In the at least one embodiment, the “obtaining” and the “acquiring” are thus used properly.

The hardware configuration of the processing device 10 is not limited to the above-mentioned example. For example, the processing device 10 may include a communication interface for wired communication or wireless communication. In addition, for example, the processing device 10 may include a reading device (for example, an optical disc drive or a memory card slot) for reading a computer-readable information storage medium. In addition, for example, the processing device 10 may include an input/output terminal (for example, a USB port) for inputting/outputting data. The program and data described as being stored in the nonvolatile memory 12 in the at least one embodiment may be supplied to the processing device 10 through the communication interface, the reading device, or the input/output terminal.

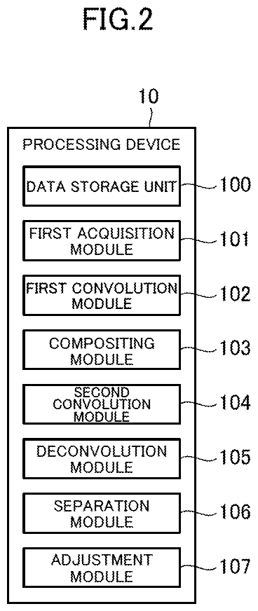

FIG. 2 is a block diagram for illustrating an example of functions implemented by the processing device 10. In the at least one embodiment, the functions implemented by the processing device 10 are described by taking processing for separating a sound as an example. As in a modification example described later, the processing device 10 may execute processing other than the processing for separating a sound. As illustrated in FIG. 2, in the processing device 10, a data storage unit 100, a first acquisition module 101, a first convolution module 102, a compositing module 103, a second convolution module 104, a deconvolution module 105, a separation module 106, and an adjustment module 107 are implemented. The data storage unit 100 is implemented mainly by the nonvolatile memory 12, and each of the other functions is implemented mainly by the CPU 11.

The data storage unit 100 stores data required for executing processing described in the at least one embodiment. In the at least one embodiment, a spectrogram of a sound signal, training data, and a learning model are described as examples of the above-mentioned data.

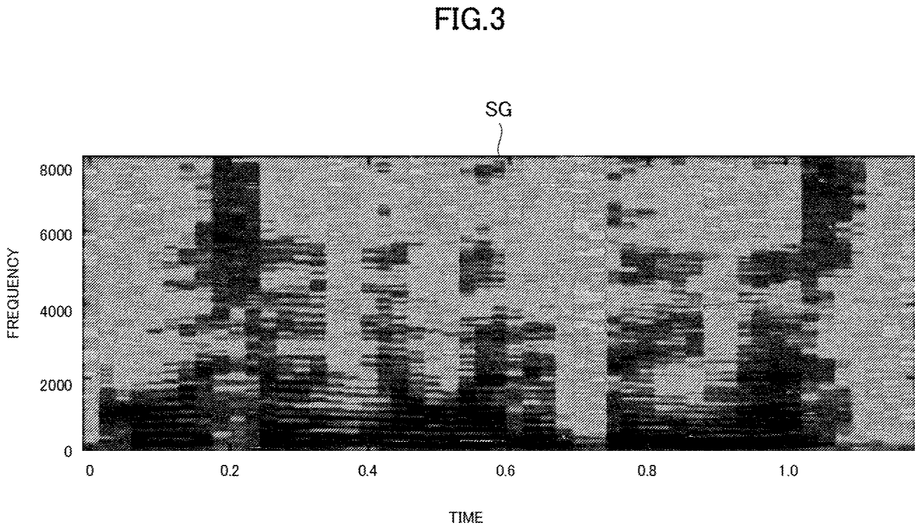

FIG. 3 is a view for showing an example of the spectrogram of the sound signal. A spectrogram SG is obtained by transforming a sound signal from a time domain into a frequency domain through use of short-time Fourier transform, a band-pass filter, or the like. In the at least one embodiment, a spectrogram to be processed for sound separation is denoted by “SG”. A spectrogram and the like included in the training data are not denoted by “SG”.

For example, the spectrogram SG is two-dimensional data. The horizontal axis is a time axis. The vertical axis is a frequency axis. For example, the spectrogram SG is represented in a two-dimensional format. The data having a two-dimensional format may be image data.

Each value of the spectrogram SG indicates the intensity (amplitude) of each frequency component in the corresponding frame. In the example of FIG. 3, the color of each pixel is schematically expressed by the density of halftone dots. For example, the brightness of a color of a pixel indicates the intensity of a frequency of a sound signal at a time corresponding to the pixel. The relationship between the color and the intensity of the frequency is not limited thereto, and may be any relationship. In the at least one embodiment, data to be used for one process in the spectrogram SG is set to have a size of 100×2,000, but this size (number of bins and number of frames) may be any size. When “X×Y” (where X and Y represent natural numbers) is described in the at least one embodiment, this description represents the size of data. For example, X is a data count on the frequency axis, and Y is a data count on the time axis.

The spectrogram SG is not limited to the example of FIG. 3. The spectrogram SG may have any format. The spectrogram SG may be a logarithmic scale instead of a linear scale.

The spectrogram SG in the at least one embodiment is calculated from a sound signal in which a plurality of sounds including a predetermined sound are mixed. The predetermined sound is a sound to be separated. The predetermined sound may be a single sound (solo signal), or may be a plurality of sounds (mixed signal).

For example, the predetermined sound may be a human voice, and another sound may be a sound of a musical instrument. In this case, the spectrogram SG indicates a sound signal in which the human voice and the sound of the musical instrument are mixed. The human voice is separated from this sound signal by the processing in the at least one embodiment.

The data storage unit 100 stores training data in machine learning or deep learning. The machine learning or the deep learning itself can utilize various approaches in image and voice processing. In the at least one embodiment, a convolutional neural network is taken as an example. A specific example of the convolutional neural network may be an approach called “U-Net” for extracting a particular area from an image or such an approach using U-Net as described in Andreas Jansson, Eric Humphrey, Nicola Montecchio, Rachel Bittner, Aparna Kumar, Tillman Weyde, “SINGING VOICE SEPARATION WITH DEEP U-NET CONVOLUTIONAL NETWORKS,” ISMIR, 2017. An approach employed in the at least one embodiment has a general framework slightly similar to that of the related-art approach, but has specific processing fundamentally different therefrom.

The training data is used for training the learning model (adjustment of variables). The training data is a pair of input and output (correct answer). In other words, the training data is a pair of data having the same format as that of data to be input to the learning model and data serving as a correct answer supposed to be output by the learning model. In the at least one embodiment, the training data means one pair. For example, the data storage unit 100 stores a plurality of pieces of training data having details different from each other.

In the at least one embodiment, the training data includes a spectrogram of a sound signal in which a plurality of sounds are mixed, which serves as the input, and a spectrogram of a signal of a predetermined sound included in the plurality of sounds, which serves as the output. This spectrogram has the same format as that of the spectrogram SG (spectrogram SG to be separated) to be input to the learning model. This predetermined sound is represented in the same format as that of the data to be output by the learning model.

For example, the spectrogram of the sound signal included in the training data is data having a two-dimensional format. This spectrogram has one axis set as the frequency axis and the other axis set as the time axis.

For example, the training data is provided by a user of the processing device 10. The user individually records a predetermined sound to be separated and another sound. The user mixes the recorded predetermined sound with the other sound to obtain a mixed sound, and transforms the mixed sound into data in the frequency domain to obtain a spectrogram of the mixed sound. The user creates, as the training data, a pair in which this spectrogram of the mixed sound is set as the input and a spectrogram of the predetermined sound recorded first is set as the output (correct answer). The user performs the same work on various sounds to create a plurality of pieces of training data (data set).

The data storage unit 100 stores the learning model. In the at least one embodiment, the learning model is trained by supervised learning. For example, the learning model includes an encoder formed of a plurality of layers and a decoder formed of a plurality of layers. In the at least one embodiment, a case in which the encoder and the decoder at the same hierarchical level are subjected to skip connections is described, but the skip connections may be omitted.

The encoder includes a plurality of convolutional layers and one or more pooling layers. The decoder includes a plurality of deconvolutional layers and one or more upsampling layers, which correspond to the respective layers of the encoder. Those layers form a convolutional neural network. For example, the learning model includes variables such as convolution coefficients. Filter coefficients and biases are examples of variables.

For example, the data storage unit 100 stores a learning model that has not been trained. The learning model that has not been trained is a learning model before having variables adjusted by the adjustment module 107 described later. A learning model having the variables adjusted is stored in the data storage unit 100 as a trained model. When additional training is executed, the variables of the trained model are updated by the additional training.

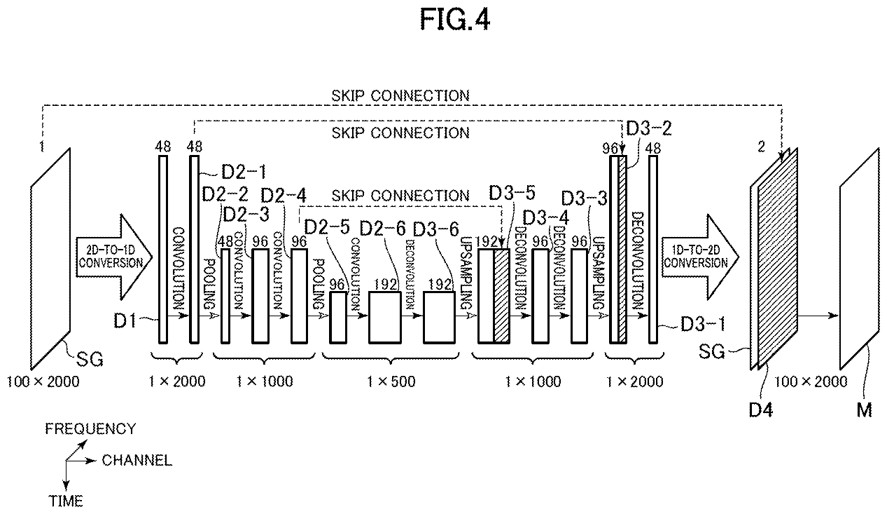

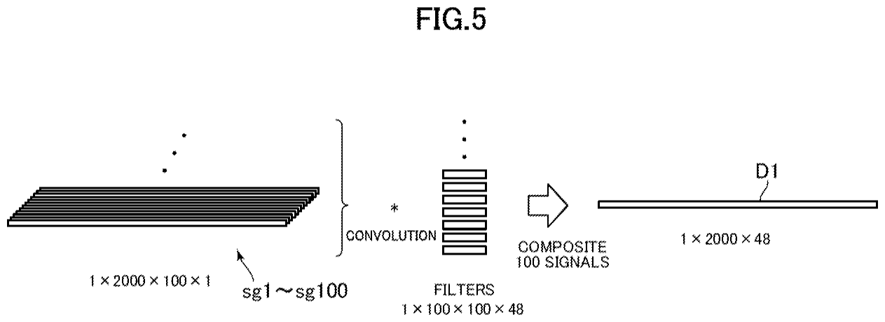

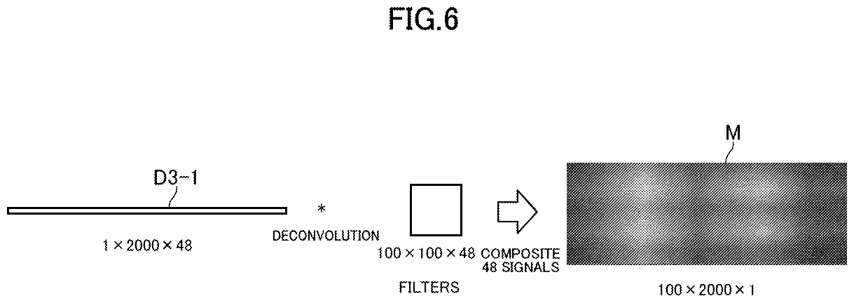

FIG. 4 is a diagram for illustrating an overall flow of processing to be executed by the learning model. FIG. 5 is a diagram for illustrating processing for processing a sliced two-dimensional spectrogram to obtain one-dimensional data. FIG. 6 is a diagram for illustrating processing for processing the one-dimensional data to obtain two-dimensional data. The first convolution module 102, the compositing module 103, and the second convolution module 104 are encoders, and the deconvolution module 105 is a decoder. Now, details of each of those functions are described with reference to FIG. 4 to FIG. 6.

The first acquisition module 101 acquires the spectrogram SG of a sound signal. When the sound signal is longer than 2,000 frames, the sound signal is subjected to processing by being divided into spectrograms in units of 2,000 frames. In this case, a plurality of spectrograms may be used for training the learning model regarding the separation of the same sound signal.

For example, the processing device 10 calculates the frequency spectrum of the sound signal based on a publicly known algorithm to generate the spectrogram SG. The sound signal is stored in the data storage unit 100, an external device, or an external information storage medium. The processing device 10 may convert the sound signal input from the input unit 16 into digital data to generate the spectrogram SG.

The first convolution module 102 performs a first convolution on the spectrogram SG by a filter having the same width every predetermined width on the frequency axis or the time axis. The predetermined width is a width having a fixed length on the frequency axis or the time axis. The predetermined width may match a resolution of the frequency axis or the time axis, or may be an integral multiple of the resolution.

In the at least one embodiment, the spectrogram SG is represented in a two-dimensional format, and the predetermined width is a width of a resolution of at least one. The predetermined width and the number of dimensions of first feature data (result of the convolution) described later are mutually independent values. In the at least one embodiment, the first convolution module 102 performs the first convolution on the spectrogram SG every predetermined width on the frequency axis.

In the at least one embodiment, the predetermined width is the width of one frequency bin. One frequency bin is the resolution of the frequency in the spectrogram SG. The first convolution module 102 may perform the first convolution every two frequency bins or every three frequency bins.

The first convolution is a convolution performed in the first convolutional layer (first stage convolutional layer) of the encoder. The first convolution and composition immediately thereafter are performed as often as the number of, for example, 48 channels. A second convolution, which is described later, is a convolution to be performed in a plurality of convolutional layers after the convolutional layer of the first convolution. Those convolutions are part of the processing to be executed by the learning model.

As the filter in the first convolution, a filter having a length in a time axis direction longer than the width in a frequency axis direction is used. For example, a filter having a size of 1×100 is used. The filter may have another size, and for example, the width on the time axis may be tens to hundreds of times or more the length on the frequency axis. The number of filters may be any number. For example, the same number of filters as the number of components (for example, number of bins) of the spectrogram SG are provided.

The two-dimensional spectrogram SG is regarded as a group of signals having a predetermined width (for example, one bin), in which the number of included signals having the predetermined width is equal to the number obtained by dividing the data count by the predetermined width (for example, (total number of frequency bins)/1). For example, when the spectrogram SG is two-dimensional data of 100×2,000, it is considered that there are 100 one-dimensional signals having a width of 1 and a length of 1,000. In other words, the spectrogram SG is sliced every predetermined width in a frequency direction. In FIG. 5, the individual one-dimensional signals are denoted by reference symbols sg1 to sg100.

The first convolution module 102 performs the first convolution on the spectrogram SG every predetermined width (for example, 1 bin) by a filter having the predetermined width and a predetermined length (for example, 100 frames) for a plurality of channels. That is, the width based on which the spectrogram SG is sliced and the width of the filter are the same. In the at least one embodiment, a filter is provided independently for each width of the predetermined length. The first convolution module 102 convolves the spectrogram SG by a corresponding filter every width of a predetermined length.

As illustrated in FIG. 5, the first convolution module 102 convolves each of the one-dimensional signals sg1 to sg100 by a one-dimensional filter. For example, the one-dimensional signal in the first row is subjected to the first convolution by a 1×100 filter for the first row. The one-dimensional signal in the second row is subjected to the first convolution by a 1×100 filter for the second row. The same applies to the third and subsequent rows. The filter for each row has an individual coefficient. In the first convolution, a padding of 50 is set before and after in the time axis direction to maintain the data size. There may be no particular padding, and reduction in data size may be allowed to some extent. The compositing module 103, which is described later, combines results of the convolution to obtain data dl of 1×2,000.

A stride width of the filter is 1. The filter may be common to a plurality of one-dimensional signals instead of being provided for each one-dimensional signal (one frequency bin). For example, one filter common to all the one-dimensional signals may be provided.

The compositing module 103 obtains, for each channel, one-dimensional first feature data D1 by combining pieces of data which have been obtained by the first convolution performed every predetermined width and the number of which is obtained by dividing the entire width by the predetermined width. In the example of FIG. 5, individual pieces of data of 1×2,000 obtained by convolving each of the one-dimensional signals sg1 to sg100 by each 1×100 filter are the results of the first convolution.

Combining the results of the first convolution is to compile the individual results into a single piece of data. In other words, combining the results of the first convolution means uniting, compositing, or accumulating the individual pieces of data of 1×2,000 to obtain one piece of data having the same size. In the example of FIG. 5, adding and compositing the above-mentioned 100 pieces of data (data having a size of 1×2,000) to obtain the first feature data D1 of 1×2,000 corresponds to combining the results of the first convolution.

The one-dimensional first feature data D1 is feature data having a data count of 1 on the frequency axis or the time axis. For example, the first convolution is performed every frequency bin to obtain one-dimensional data corresponding to the data count on the time axis.

The feature data refers to data indicating features of the sound signal indicated by the spectrogram SG. In other words, the feature data is data obtained by at least one convolution. When the first feature data D1 has a size of 1×1,000, the first feature data D1 includes 1,000 feature amounts. The feature data may be called “feature map” mainly in a case of two-dimensional data. In the first feature data D1, features of the respective frequency bins are combined into one.

As illustrated in FIG. 4, as the results of the first convolution and the composition, first feature data D1 having a size of 1×2,000 and corresponding to 48 channels are obtained. The second convolution module 104, which is described later, convolves the first feature data D1 by a one-dimensional filter to obtain second feature data D2-1 (having a size of 1×2,000) corresponding to 48 channels, and performs a pooling to obtain second feature data D2-2 of 1×1,000 corresponding to 48 channels.

For example, the compositing module 103 calculates a sum of the results of the first convolution to obtain the first feature data D1. The first feature data D1 may be a sum obtained by giving a predetermined weight to each of the results of the first convolution and adding up the results, instead of a simple sum of the results of the first convolution. The first feature data D1 may be obtained by substituting the results of the first convolution into a calculation formula including a mathematical expression other than the sum.

The second convolution module 104 performs at least one second convolution on the first feature data D1 to encode the first feature data D1 and obtain one-dimensional second feature data D2 indicating features of the spectrogram SG. As the second feature data D2, any one of data D2-1 to data D2-6 obtained in respective layers of the second convolution may be used. Pieces of data obtained in any two or more layers may be composited to obtain the second feature data D2. The second convolution is a convolution to be performed after the first convolution. In the at least one embodiment, it is assumed that a padding is set in the second convolution to maintain the data size before and after the convolution. There may be no particular padding, and the size may be reduced to some extent.

The first feature data D1 is one-dimensional, and hence the second convolution is a one-dimensional convolution to be performed on the one-dimensional data. For example, the second convolution module 104 performs at least one second convolution and a pooling on the first feature data D1 to obtain the second feature data D2 (any one of the data D2-1 to the data D2-6).

The pooling is a pooling to be performed by a pooling layer arranged immediately after a predetermined convolutional layer in the second convolution.

In the example of FIG. 4, the second convolution module 104 performs the second convolution of 48 channels in the first layer on the first feature data D1 of 1×1,000 corresponding to 48 channels to obtain the data D2-1 of 1×2,000 corresponding to 48 channels, and the size of the data D2-1 is reduced by the pooling to obtain the data D2-2 of 1×1,000 corresponding to 48 channels.

The second convolution module 104 performs the second convolution in the second layer on the data D2-2 to obtain the data D2-3 of 1×1,000 corresponding to 96 channels. The second convolution module 104 performs the second convolution in the third layer on the data D2-3 to obtain data D2-4 of 1×1,000 corresponding to 96 channels. The second convolution module 104 reduces the size of the data D2-4 by the pooling to obtain the data D2-5 of 1×500 corresponding to 96 channels. The second convolution module 104 performs the second convolution in the fourth layer on the data D2-5 to obtain the data D2-6 of 1×500 corresponding to 192 channels.

In the at least one embodiment, the second convolution is performed by the one-dimensional filter, and hence the second convolution module 104 performs at least one second convolution and a pooling on the first feature data D1 by the one-dimensional filter to obtain the second feature data D2. As the second convolution filter, a filter having any size can be used. In the at least one embodiment, a filter that is long in the time axis direction (filter having a longer time axis width than a frequency axis width) is used. For example, a filter having a size of 1×100 is used. The number of channels may be any number.

The deconvolution module 105 performs at least one deconvolution on the second feature data D2 to obtain a mask M for separating a predetermined sound. The deconvolution is processing to be performed in deconvolutional layers included in the convolutional neural network. It is assumed that the deconvolutional layers are present in a one-layer-to-one-layer correspondence with the convolutional layers of the encoder. For example, the data D2-6 is used as the second feature data. The skip connection from the second convolution in the first layer and the skip connection from the second convolution in the third layer, which are illustrated in FIG. 4, may be regarded as the second feature data.

As illustrated in FIG. 4, the deconvolution module 105 performs a deconvolution corresponding to the second convolution in the fourth layer on the data D2-6 corresponding to 192 channels to obtain data D3-6 of 1×500 corresponding to 192 channels. In the process of calculating the data D3-6 corresponding to 192 channels, the deconvolution module 105 simultaneously performs upsampling to obtain data D3-5 of 1×1,000 corresponding to 192 channels. The upsampling is implemented by stride at the time of the deconvolution in the immediately preceding stage, and is also called “unpooling.”

The deconvolution module 105 performs a deconvolution corresponding to the second convolution in the third layer on the data D3-5 corresponding to 192 channels to obtain data D3-4 of 1×1,000 corresponding to 96 channels. The deconvolution module 105 performs a deconvolution corresponding to the second convolution in the second layer on the data D3-4 corresponding to 96 channels to obtain data D3-3. In the process of calculating the data D3-3, the deconvolution module 105 simultaneously performs upsampling to obtain data D3-2 of 1×2,000 corresponding to 96 channels. The deconvolution module 105 performs a deconvolution corresponding to the second convolution in the first layer on the data D3-2 corresponding to 96 channels to obtain data D3-1 of 1×2,000 corresponding to 48 channels.

As illustrated in FIG. 6, the deconvolution module 105 performs a deconvolution serving as 1D/2D conversion on each of the pieces of data D3-1 corresponding to the 48 channels by a filter (having a size of, for example, 100×100) for each frequency bin to obtain data D4, and further performs a conversion operation to obtain the mask M. This conversion operation may be a full connection or a convolution. In another case, weighting for each individual piece of data may be used. The mask M is data that can identify the sound to be separated. The mask M can also be regarded as a time-varying filter for acoustic signal processing.

For example, the data D4 and the mask M are data having the same size as that of the spectrogram SG. In the example of FIG. 6, the sound to be separated (sound to be passed through the mask M) is expressed by the color of each piece of data in the mask M.

For example, when a certain bin at a certain time of the mask M is white, a sound having the frequency of the certain bin is passed through the mask M at the certain time, and when the certain bin is black, the sound of the frequency of the certain bin is blocked (removed). The sound to be separated is a component of the predetermined sound described above. A sound that is not to be separated is the other sound described above. Black may mean the sound to be separated, and white may mean the sound that is not to be separated. A degree of separation may be expressed by a color. The degree of separation is a probability of being the sound to be separated. For example, in a case of the mask M having 256 steps, when a probability that a certain bin at a certain time is a component of the predetermined sound is 50%, the value is expressed by an intermediate value such as 128.

In addition, in the at least one deconvolution, a deconvolution may be performed by uniting, to the input data in each layer, the data obtained in the corresponding convolutional layer. The uniting of the data may be realized as a skip connection used in, for example, U-Net or RESNET. Any one of concatenation or summation may be used in the skip connection. The skip connection supplies the result of a second convolution in one layer to the input of the corresponding deconvolution of the same layer. With the skip connection, information which is lost in processing in a layer of the encoder and unavailable in layers below the layer can be recovered in the corresponding layer of the decoder. In the example of FIG. 4, the output data D2-1 of the second convolution in the first layer is skip-connected to the input of the deconvolution in the first layer.

The output data D2-4 of the second convolution in the third layer is skip-connected to the input of the deconvolution in the third layer. The output data D1 of the first convolution and composition (2D/1D conversion) is skip-connected to the input of the deconvolution serving as the 1D/2D conversion. After the separation of a predetermined sound has been trained, the separation module 106 applies the mask M to the spectrogram SG to separate the predetermined sound from a plurality of sounds. Applying the mask M refers to separating a sound through use of the mask M. The separation module 106 uses the mask M to separate a part of components of the plurality of sounds indicated in the spectrogram SG as the predetermined sound. For example, the separation module 106 separates the predetermined sound from the mixed sound of the plurality of sounds by multiplying the spectrogram SG by the mask M. For example, the separated sound is represented as a spectrogram PS.

The spectrogram PS obtained by the separation module 106 is converted into a sound signal and recorded in the data storage unit 100.

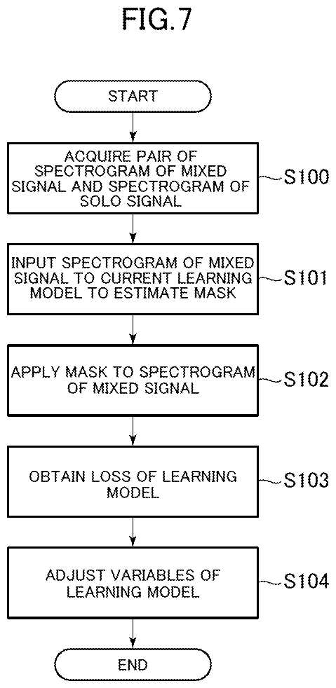

The adjustment module 107 adjusts variables to be used for the first convolution, the second convolution, and the deconvolution by a machine learning approach. Those variables are variables determined by being repeatedly adjusted so that a particular sound of the training data is separated from the spectrogram SG of the training data by the method described in the at least one embodiment. The adjustment module 107 adjusts the variables of the learning model that has not been trained so that the relationship between the input and the output included in the training data can be obtained. For example, details of processing of the adjustment module 107 are described later as the processing of FIG. 7.

In the at least one embodiment, as an example of processing to be executed by the processing device 10, adjustment processing for adjusting variables of the learning model and separation processing for separating the predetermined sound signal from the mixed signal are described. Each of the adjustment processing and the separation processing is executed by the CPU 11 operating in accordance with a program stored in the nonvolatile memory 12. Each of the adjustment processing and the separation processing is an example of the processing to be executed by the functional blocks illustrated in FIG. 2.

FIG. 7 is a flow chart for illustrating an example of the adjustment processing. This adjustment processing (training) using one or a plurality of pairs is repeatedly performed until a loss of the learning model clears a predetermined criterion. As illustrated in FIG. 7, the CPU 11 acquires a pair of a spectrogram of a mixed signal (the mixed sound) and a spectrogram of a solo signal (the predetermined sound) from a data set of training data stored in the nonvolatile memory 12 (Step S100). When a plurality of pairs are stored in the nonvolatile memory 12, the CPU 11 sequentially acquires those plurality of pairs.

The CPU 11 inputs the spectrogram of the mixed signal included in the pair acquired in Step S100 to the current learning model (learning model before the adjustment of the variables) to estimate the mask M (Step S101). When the spectrogram of the mixed signal is input to the learning model, a series of processes described with reference to FIG. 4 (processing steps similar to those of the separation processing described later) is executed. The learning model performs the first convolution to obtain the first feature data D1 of the spectrogram of the mixed signal. The learning model performs at least one second convolution on the first feature data D1 to obtain the second feature data D2 of the spectrogram of the mixed signal. The learning model performs at least one deconvolution on the second feature data D2 to estimate the mask M.

The CPU 11 applies the mask M to the spectrogram of the mixed signal to obtain a spectrogram of a separated signal (Step S102). The spectrogram of the separated signal obtained in Step S102 is a spectrogram obtained by the current learning model. This spectrogram is used to evaluate performance of the current learning model in the subsequent processing step of Step S103.

The CPU 11 compares the spectrogram of the separated signal and the spectrogram of the solo signal to each other to obtain a loss of the learning model, representing difference between these two spectrograms (Step S103). As the loss, the L1 norm may be used in the same manner as used in Andreas Jansson, Eric Humphrey, Nicola Montecchio, Rachel Bittner, Aparna Kumar, Tillman Weyde, “SINGING VOICE SEPARATION WITH DEEP U-NET CONVOLUTIONAL NETWORKS,” ISMIR, 2017, or the L2 norm or the like may be used instead. The loss is information to be used as an indicator of the performance of sound separation by the learning model (Smaller loss means better performance of the model). In other words, the loss corresponds to the difference between the spectrogram of the separated signal and the spectrogram of the solo signal. If the loss is large, it means the performance of the current learning model is low, and big adjustment for the variables are required.

The CPU 11 adjusts the variables of the learning model based on the loss obtained in Step S103 (Step S104) so as to reduce the loss. The adjustment of variables itself may be performed by general back propagation of the loss. After that, the processing steps of from Step S100 to Step S104 are repeatedly performed until the loss becomes sufficiently smaller, and the training of the learning model is completed.

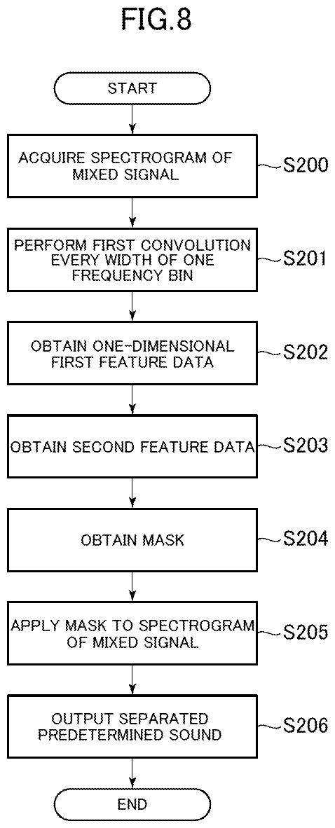

FIG. 8 is a flow chart for illustrating an example of the separation processing. As illustrated in FIG. 8, the CPU 11 acquires the spectrogram SG of the mixed signal stored in the nonvolatile memory 12 (Step S200). The spectrogram SG acquired in Step S200 is the spectrogram SG to be subjected to the sound separation.

The CPU 11 performs the first convolution on the spectrogram SG of the mixed signal every width of one frequency bin (Step S201). In Step S201, the CPU 11 regards the spectrogram SG (of, for example, 100×2,000) of the mixed signal as a one-dimensional signal (of, for example, 1×2,000×100) for each width of one frequency bin, and performs the first convolution on the spectrogram SG by the filters (of, for example, 1×100×100×48) corresponding to the respective frequency bins.

The CPU 11 calculates a sum of 100 results of the first convolution performed in Step S201 to obtain the one-dimensional first feature data D1 (of, for example, 1×2,000×48) (Step S202). In the example of FIG. 4, the first feature data D1 is obtained by the processing step of Step S202.

The CPU 11 performs at least one second convolution and, as required, a pooling on the first feature data D1 by a one-dimensional filter to obtain the second feature data D2 (of various sizes) (Step S203). In the example of FIG. 4, the data D2-1 to the data D2-6 are obtained by the processing step of Step S203, and in this case, the data D2-6 is used as the second feature data D2. The processing steps of from Step S201 to Step S203 form the encoding processing.

The CPU 11 performs decoding processing including at least one deconvolution on the second feature data D2 to obtain a mask M (Step S204). In the case of the example of FIG. 4, the data D3-6 to the data D3-1, the data D4, and the mask M are obtained by the processing step of Step S204.

The CPU 11 applies the mask M to the spectrogram SG of the mixed signal to separate the predetermined sound from the mixed sound of the plurality of sounds (Step S205). In Step S205, the CPU 11 separates the spectrogram of the predetermined sound from the spectrogram of the mixed sound by multiplying the spectrogram SG of the mixed signal by the mask M. The CPU 11 transforms the spectrogram PS of the separated sound from the frequency domain to the time domain through use of short-time inverse Fourier transform or the like to obtain the digital data of the separated predetermined sound signal. This digital data is recorded in the nonvolatile memory 12.

The CPU 11 outputs the separated predetermined sound from the speaker 17 (Step S206), and this process is ended. In Step S206, the CPU 11 reproduces the digital data recorded in Step S205, and outputs the separated predetermined sound.

The processing device 10 according to the at least one embodiment obtains the one-dimensional first feature data D1 by combining the results of the first convolution performed every predetermined width, thereby being capable of obtaining the feature data that efficiently represents the features of the spectrogram SG of the sound signal. For example, in a case of a sound having characteristic information over a wide range in the frequency direction (sound having a local feature in the time axis direction), the first convolution is performed every predetermined width on the time axis to obtain the one-dimensional data (of, for example, 100×1) in the frequency direction, which indicates information over a wide range in the frequency direction. For example, in a case of a sound having characteristic information over a wide range in a time direction (sound having a local feature in the frequency direction), the first convolution is performed every predetermined width on the frequency axis to obtain the one-dimensional data (of, for example, 1×2,000) in the time axis direction, which indicates information over a wide range in the time direction. According to the processing device 10, in the encoding processing, all the processing steps after the first feature data D1 is obtained are the processing steps to be performed on the one-dimensional data, and hence the feature data can be efficiently obtained. As a result, it is possible to speed up processing for obtaining the feature data. It is also possible to reduce a processing load on the processing device 10. In the case of using one-dimensional data in the time axis direction, with the same amount of data and amount of calculation, it is possible to implement a filter that is longer in the time direction, and information in the time direction can be efficiently taken into consideration in that respect as well. A spectral time series of a waveform is converted into one-dimensional data in a certain axial direction to perform inference, and variables are interchanged between components in the other axial direction, thereby being capable of efficiently performing the inference through use of a learning model having the same scale.

The processing device 10 combines the results of the first convolution to obtain the first feature data D1. The processing device 10 performs at least one second convolution and a pooling on the first feature data D1 to obtain the second feature data D2. The size of the feature data is reduced by the pooling, thereby being capable of obtaining the feature data more efficiently.

In the at least one deconvolution, the processing device 10 performs the deconvolution by adding, to the input data in each layer, the data obtained in the corresponding convolutional layer, thereby improving the accuracy of the deconvolution. The accuracy of the mask M is improved, and the accuracy of the sound separation can also be improved.

The present disclosure is not limited to the at least one embodiment described above, and can be modified suitably without departing from the spirit of the present disclosure.

For example, the case in which a pooling is executed after the convolution has been described, but it is not required to perform a pooling in particular and to reduce the data size. The case in which the first convolution using the one-dimensional filter is executed has been described, but it suffices that the first feature data D1 becomes one-dimensional, and a two-dimensional filter may be used for the first convolution.

In the at least one embodiment, the case in which the processing device 10 is used for voice separation has been described, but the processing device 10 can be used in any other scene. For example, the processing device 10 may be used for voiceprint authentication. In a case of voiceprint authentication for determining whether or not a voice is a certain particular human voice, variables of a learning model are adjusted based on training data including the spectrogram SG of the sound signal indicating a human voice and information indicating whether or not the human voice is the certain particular human voice (information indicating whether the human voice is a positive example or a negative example). The processing device 10 inputs, to the learning model, the spectrogram SG to be subjected to the voiceprint authentication. The learning model performs such a first convolution and a second convolution as described in the at least one embodiment to obtain the one-dimensional second feature data D2. The learning model outputs authentication information corresponding to the second feature data D2. This authentication information indicates a probability that the voice is a particular human voice that has been learned, and when this value is larger than a threshold value, it is determined that “the voice is a particular human voice.” In the case of the voiceprint authentication, the deconvolution is not performed.

In a case of voiceprint authentication for identifying an utterer from among a plurality of humans, variables of a learning model are adjusted based on training data including the spectrogram SG of a sound signal indicating a human voice and identification information that identifies this human (for example, label ID that uniquely identifies the human). The processing device 10 inputs, to the learning model, the spectrogram SG to be subjected to the voiceprint authentication. The learning model performs such a first convolution and a second convolution as described in the at least one embodiment to obtain the one-dimensional second feature data D2. The learning model outputs the label ID corresponding to the second feature data D2. In addition to the voice separation and the voiceprint authentication, the processing device 10 can be used in any scene, such as music genre estimation or noise removal from a sound signal. A processing system for implementing the above-mentioned processing is not limited to one processing device 10. The processing system may include a plurality of devices connected to each other by a network or a serial bus.

While there have been described what are at present considered to be certain embodiments of the disclosure, it will be understood that various modifications may be made thereto, and it is intended that the appended claims cover all such modifications as fall within the true spirit and scope of the disclosure.

What is claimed is:

1. A processing apparatus, comprising:
one or more processors; and
one or more memories operatively coupled to the one or more processors, wherein the one or more processors are configured to:
acquire a spectrogram of a sound signal;
perform a first convolution on the spectrogram at every predetermined width on one of a frequency axis or a time axis;
combine results of the first convolution to obtain one-dimensional first feature data; and
perform at least one second convolution on the one-dimensional first feature data to obtain one-dimensional second feature data indicating a feature of the spectrogram.

2. A processing method comprising:
acquiring with one or more processors, a spectrogram of a sound signal;
performing with the one or more processors, a first convolution on the spectrogram at every predetermined width on one of a frequency axis or a time axis;
combining with the one or more processors, results of the first convolution performed to obtain one-dimensional first feature data; and
performing, with the one or more processors, at least one second convolution on the one-dimensional first feature data to obtain one-dimensional second feature data indicating a feature of the spectrogram.

3. The method according to claim 2, wherein
in performing the at least one second convolution, a pooling is performed on the one-dimensional first feature data to obtain the one-dimensional second feature data, besides the at least one second convolution.

4. The method according to claim 2, wherein
the first convolution on the spectrogram is performed using a filter having the predetermined width and a predetermined length; and
the at least one second convolution on the one-dimensional first feature data is performed using a one-dimensional filter.

5. The method according to claim 2, wherein the predetermined width is on the frequency axis.

6. The method according to claim 5, wherein the predetermined width is a width of one frequency bin.

7. The method according to claim 2, wherein the combining the results of the first convolution is calculating a sum of the results of the first convolution to obtain the one-dimensional first feature data.

8. The method according to claim 4, wherein
a filter is provided independently for each width of the predetermined length on the frequency axis or on the time axis; and
the first convolution on the spectrogram at every width of the predetermined length is performed using the filter corresponding to the width.

9. The method according to claim 2, wherein
in the sound signal represented by the spectrogram, a plurality of sounds are mixed, and
the method further comprises:
performing at least one deconvolution on the one-dimensional second feature data to obtain a mask for separating the predetermined sound; and
applying the mask to the spectrogram to separate a spectrogram of a predetermined sound in the plurality of sounds from the spectrogram of the sound signal including the plurality of sounds.

10. The method according to claim 9, the at least one deconvolution corresponds to the at least one second convolution one-layer-to-one-layer, and is performed on input data from a previous layer of the deconvolution, united with skip data from the corresponding second convolution.

11. The method according to claim 9, wherein the first convolution, the second convolution, and the deconvolution consists a learning model, and variables of the learning model are determined by an adjustment process using training data including a spectrogram of a mixed sound of recorded sounds and a spectrogram of a solo sound in the recorded sounds, the variables being repeatedly adjusted in the adjustment process so that difference between the separated spectrogram calculated from the spectrogram of the mixed sound using the learning model and the spectrogram of the solo sound is reduced.

12. A non-transitory computer readable storage medium having stored thereon computer-readable instructions, which when executed by one or more processors, cause the one or more processors to perform the steps of:
acquiring a spectrogram of a sound signal;
performing a first convolution on the spectrogram at every predetermined width on one of a frequency axis or a time axis;
combining results of the first convolution to obtain one-dimensional first feature data; and
performing at least one second convolution on the one-dimensional first feature data to obtain one-dimensional second feature data indicating a feature of the spectrogram.
